(19) United States
(12) Patent Application Publication
(10) Pub. No.: US 2026/0350993 A1
(43) Pub. Date: Nov. 5, 2026

(54) SUMMARIZATION OF VIDEO GAME FRAMES USING GENERATIVE MACHINE LEARNING

(71) Applicant: Microsoft Technology Licensing, LLC, Redmond, WA (US)

(72) Inventors: Michael G. CHEMISTRUCK, Sammamish, WA (US); Michael Jacob MARIAN, Hendersonville, NC (US); Daniel CHEMISTRUCK, La Mesa, CA (US)

(73) Assignee: Microsoft Technology Licensing, LLC, Redmond, WA (US)

(21) Appl. No.: 19/194,759

(22) Filed: Apr. 30, 2025

(51) Int. Cl. G06V 20/40; G06N 3/0475; G06V 10/82; G11B 27/031

(52) U.S. Cl. CPC G06V 20/47; G06N 3/0475; G06V 10/82; G11B 27/031

(57) ABSTRACT

This document relates to summarization of video frames output by a video game using a generative machine learning model. For instance, a sequence of video frames output by a video game during a gaming session can be collected. Then, a generative machine learning model can be instructed to generate frame narratives describing the frames. The frame narratives can then be employed by the generative machine learning model to generate an overall summary of the gaming session, which can be output to the user at a later time.

### BACKGROUND

Modern video games provide rich video gaming experiences with high-resolution graphics at high frame rates and realistic audio. However, in some cases it can be difficult for game players that step away from a game for some time to re-immerse themselves seamlessly back into the video gaming experience. For instance, a video game player might take a few days away from playing a video game due to work commitments, or even a few months away from playing the video game due to a major life event. When that player resumes playing the video game, they may find that they have forgotten what happened during their previous gaming session.

One way to remind a video game player of a previous video gaming session is to display a static screenshot from a previous gaming session. While this can be a helpful reminder, a static screenshot does not convey a great deal of information to the video game player. Thus, a mere screenshot may not be sufficient to adequately remind the video game player of their prior video gaming experiences. This may degrade the player's experience the next time they play the game, as it may take some time for them to reorient themselves into the gaming experience.

### SUMMARY

This Summary is provided to introduce a selection of concepts in a simplified form. These concepts are further described below in the Detailed Description. This Summary is not intended to identify key features or essential features of the claimed subject matter, nor is it intended to be used to limit the scope of the claimed subject matter.

The description generally relates to techniques for summarizing video game sessions. One example includes a computer-implemented method that can include collecting a sequence of video frames that are output during a video game session involving a video game player playing a video game. The method can also include instructing a generative machine learning model to generate respective frame narratives describing individual video frames from the sequence. The method can also include instructing the generative machine learning model to generate an overall narrative describing the video game session based at least on the respective frame narratives. The method can also include outputting a summary of the video game session to the video game player, the summary including the overall narrative and the individual video frames.

Another example entails a system that includes a processor and a storage medium storing instructions. When executed by the processor, the instructions can cause the system to collect a sequence of video frames that are output during a video game session involving a video game player playing a video game. The instructions can also cause the system to instruct a generative machine learning model to generate respective frame narratives describing individual video frames from the sequence. The instructions can also cause the system to instruct the generative machine learning model to generate an overall narrative describing the video game session based at least on the respective frame narratives. The instructions can also cause the system to output a summary of the video game session to the video game player, the summary including the overall narrative and the individual video frames.

Another example includes a computer-readable storage medium storing executable instructions which, when executed by a processor, cause the processor to perform acts. The acts can include collecting a sequence of video frames that are output during a video game session involving a video game player playing a video game. The acts can also include instructing a generative machine learning model to generate respective frame narratives describing individual video frames from the sequence. The acts can also include instructing the generative machine learning model to generate an overall narrative describing the video game session based at least on the respective frame narratives. The acts can also include outputting a summary of the video game session to the video game player, the summary including the overall narrative and the individual video frames.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example workflow for generating and providing summaries of video gaming sessions, consistent with some implementations of the present concepts.

FIGS. 2A, 2B, and 3A-3G illustrate example user experiences, consistent with some implementations of the present concepts.

FIGS. 20-2H illustrate examples of summary generation, consistent with some implementations of the present concepts.

FIG. 4 illustrates an example of a system in which the disclosed implementations can be performed, consistent with some implementations of the disclosed techniques.

FIG. 5 illustrates an example of a method consistent with some implementations of the present concepts.

FIG. 6 illustrates an example generative language model, consistent with some implementations of the present concepts.

FIG. 7 illustrates an example generative image model, consistent with some implementations of the present concepts.

FIG. 8 illustrates an example computer vision model, consistent with some implementations of the present concepts.

FIG. 9 illustrates an example vision language model, consistent with some implementations of the present concepts.

### DETAILED DESCRIPTION

### Overview

As noted above, modern video games can provide rich video gaming experiences. These experiences can involve complex environments, sophisticated narratives, a wide range of characters, different levels and objectives, etc. When a video game player steps away from playing a complex video game for a period of time, it may be difficult for that player to immediately pick up where they left off. For instance, the user may not recall how they got to a particular location, what equipment their character currently has, what bosses they have already beaten, what level they are currently on, etc.

A static screen shot from the most recent video gaming session could offer a player some clues as to where they left off playing a video game. For a relatively simple video game, this might be adequate. However, a single screenshot may omit important details that could be useful to help re-immerse the user into the video gaming experience. This is particularly true when the prior video gaming session involved a complex sequence of events that are pertinent to the current video gaming session.

The disclosed implementations offer techniques for generating informative narrative summaries based on snapshots of video frames output by a video game during a gaming session. For instance, video frames can be collected by a video gaming platform at a fixed rate or at selected times based on various criteria described in more detail below. Because the generated summaries provide a rich source of information describing the previous video gaming session, the player can quickly reorient themselves back into the video gaming experience.

### Machine Learning Overview

There are various types of machine learning frameworks that can be trained to perform a given task. Support vector machines, decision trees, Kolmogorov-Arnold networks, state space models, and neural networks are just a few examples of machine learning frameworks that have been used in a wide variety of applications, such as image processing, computer vision, and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with parameters for the model structure that have been trained or tuned. Note that two trained models can share the same model structure and yet have different values for the parameters, e.g., if the two models are trained on different training data or if there are underlying stochastic processes in the training process.

There are many machine learning tasks for which there is a relative lack of training data. One broad approach to training a model with limited task-specific training data for a particular task involves “transfer learning.” In transfer learning, a model is first pretrained on another task for which significant training data is available, and then the model is tuned to the particular task using the task-specific training data.

The term “pretraining,” as used herein, refers to model training on a set of pretraining data to adjust model parameters in a manner that allows for subsequent tuning of those model parameters to adapt the model for one or more specific tasks. In some cases, the pretraining can involve a self-supervised learning process on unlabeled pretraining data, where a “self-supervised” learning process involves learning from the structure of pretraining examples, potentially in the absence of explicit (e.g., manually-provided) labels. Subsequent modification of model parameters obtained by pretraining is referred to herein as “tuning.” Tuning can be performed for one or more tasks using supervised learning from explicitly-labeled training data, in some cases using a different task for tuning than for pretraining.

### TERMINOLOGY

The term “summary,” as used herein, broadly refers to any type of output that conveys information about a video gaming session. For instance, a summary can include a “frame narrative,” which is a narrative describing a particular video frame. Note that frame narratives can be generated based solely on an individual video frame, but can also be generated using additional information such as audio, chat, haptic output, etc. A summary can also include an “overall narrative,” which is a narrative describing a video gaming session, e.g., based on multiple frame narratives for frames output by the video game during that video gaming session.

A summary can also include one or more images (e.g., video frames) relating to a video gaming session, where the video frames can be the same video frames presented during that session or modified, e.g., by a generative image model. The term “event” broadly refers to any occurrence during video game play, e.g., an interaction with a video game character, encountering an enemy, obtaining an item in inventory, completing a level, etc.

The term “video game” or “video game executable” refers to an application (e.g., a binary) that implements a specific video game, such as a racing game, a fantasy game, etc. The term “platform” or “platform executable” refers to another computer program that provides various types of functionality used by multiple different game executables, such as an operating system, streaming services, user accounts, and development tools such as software development kits. A platform can have access to various inputs to a video game (e.g., video game controls) as well as outputs of the video game (e.g., video, audio, and/or haptic output). A platform may not have access to internal game state that the video game stores in memory and/or writes to storage during execution.

The term “generative model,” as used herein, refers to a machine learning model employed to generate new content. One type of generative model is a “generative language model,” which is a model that can generate new sequences of text given some input. One type of input for a generative language model is a natural language prompt, e.g., a query potentially with some additional context. For instance, a generative language model can be implemented as a neural network, e.g., a long short-term memory-based model, a decoder-based generative language model, etc. Examples of decoder-based generative language models include versions of models such as GPT, BLOOM, PaLM, Mistral, Gemini, and/or LLAMA. Generative language models can be trained to predict tokens in sequences of textual training data. When employed in inference mode, the output of a generative language model can include new sequences of text that the model generates.

Another type of generative model is a “generative image model,” which is a model that generates images or video. For instance, a generative image model can be implemented as a neural network, e.g., a generative image model such as one or more versions of Stable Diffusion, DALL-E, Sora, or GENIE. A generative image model can generate new image or video content using inputs such as a natural language prompt and/or an input image or video. One type of generative image model is a diffusion model, which can add noise to training images and then be trained to remove the added noise to recover the original training images. In inference mode, a diffusion model can generate new images by starting with a noisy image and removing the noise. Note also that generative image models can generate videos, and the term “image” also encompasses two-dimensional and three-dimensional video.

In some cases, a generative model can be multi-modal. For instance, a model may be capable of using various combinations of text, images, video, audio, application states, code, or other modalities as inputs and/or generating combinations of text, images, video, audio, application states, or code or other modalities as outputs. Here, the term “generative language model” encompasses multi-modal generative models where at least one mode of output includes natural language tokens. Likewise, the term “generative image model” encompasses multi-modal generative models where at least one mode of output includes images or video. Examples of multi-modal models include certain GPT variants such as GPT-4o, Gemini, Chameleon, etc. Multi-modal models can also include lightweight models such as Phi-3-Vision-128K-Instruct.

In addition, some generative models can include computer vision capabilities. These models are capable of recognizing objects in input images. The term “computer vision model” encompasses multi-modal models such as one or more versions of CLIP (Contrastive Language-Image Pre-Training) and BLIP (Bootstrapping Language-Image Pre-Training). Note the term “computer vision model” also encompasses non-generative models, such as ResNet, Faster-RCNN, etc. The term “vision language model” refers to any multi-modal generative model that can generate text describing images or videos, including CLIP, BLIP, Vision-and-Language BERT, Flamingo, Chameleon, etc.

The term “prompt,” as used herein, refers to input provided to a generative model that the generative model uses to generate outputs. A prompt can be provided in various modalities, such as text, an image, audio, video, etc. The term “language generation prompt” refers to a prompt to a generative model where the requested output is in the form of natural language. The term “image generation prompt” refers to a prompt to a generative model where the requested output is in the form of an image. The term “suggested” refers to output predicted by a generative machine learning model, e.g., suggested tags, suggested values, and suggested images respectively refer to tags, values, and images predicted by a generative machine learning model.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

### Example Workflow

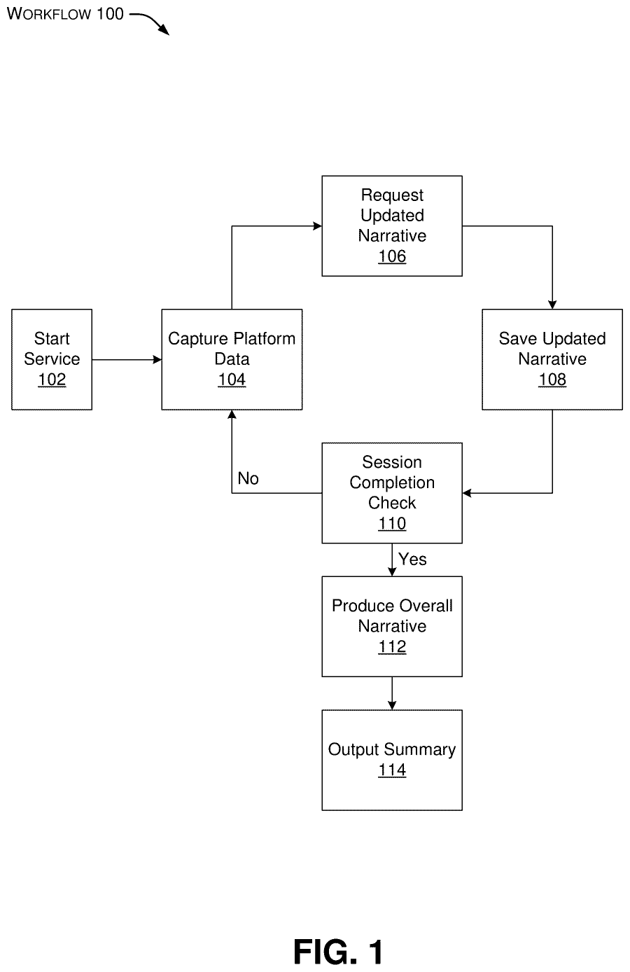

FIG. 1 illustrates a workflow 100. Start service 102 can initiate a service, e.g., by a video game platform, such as an operating system or remote streaming game service. The service can be executed externally from a video game application that a user is playing. For instance, the service can run in a separate process or thread from the video game application, have separately-allocated memory, etc.

Capture platform data 104 can capture platform data with the service. For instance, the platform data can include any data that is accessible to the platform executable-video output, audio output, haptic output, gaming inputs, platform chat, achievements, etc. For instance, in some implementations, the service captures video frames (e.g., snapshots of a video stream) at a fixed rate, e.g., once every thirty seconds.

In other implementations, the service captures video frame selectively based on one or more criteria. For instance, in some implementations, the service uses a computer vision model or other image processing techniques to determine differences in frames output by the video game, and stores frames that differ by a specified amount (e.g., a threshold) from previously-output frames. In other cases, the service stores frames in response to an application programming call from the video game. For instance, the game can call the application programming interface to indicate that a significant event has occurred, thus allowing the platform to capture frames depicting significant events while conserving storage by not storing other frames that may be redundant or otherwise not important for summary generation.

Request updated narrative 106 can obtain a narrative describing one or more items of platform data, such as individual video frames. As discussed more below, some implementations can input selected video frames to a generative machine learning model (e.g., a vision-language model) to generate textual frame narratives for frame that is input to the model. In some cases, other types of platform data such as audio, haptic output, video game inputs, platform achievements, etc., are also used for narrative generation, as described more below. Save updated narrative 108 can save updated narratives for subsequent use.

Session completion check 110 can check whether the video gaming session is complete. If not, the workflow can return to capture additional platform data while requesting and saving additional updated narratives. On the other hand, if the video gaming session is complete, the workflow can proceed to produce overall narrative 112. Here, the previously-generated frame narratives can be employed to generate an overall narrative describing the video gaming session.

Output summary 114 can output a summary of the video gaming session. For instance, the summary can include any of the collected video frames, the overall narrative, and/or the individual frame narratives. In some cases, the summary can include video frames that are selectively modified using a generative image model. As described more below, in some cases the summary is output in response to initiation of a subsequent video gaming session by the video game player.

### Example User Experiences and Summary Generation

The following generally describes some user experiences relating to playing a racing video game. First, a video game player plays a racing video game during a first gaming session. Then, the player stops playing the game for a period of time and returns to play a second session. When the player returns for a second session, a summary of the first session is presented and then the player plays the second session.

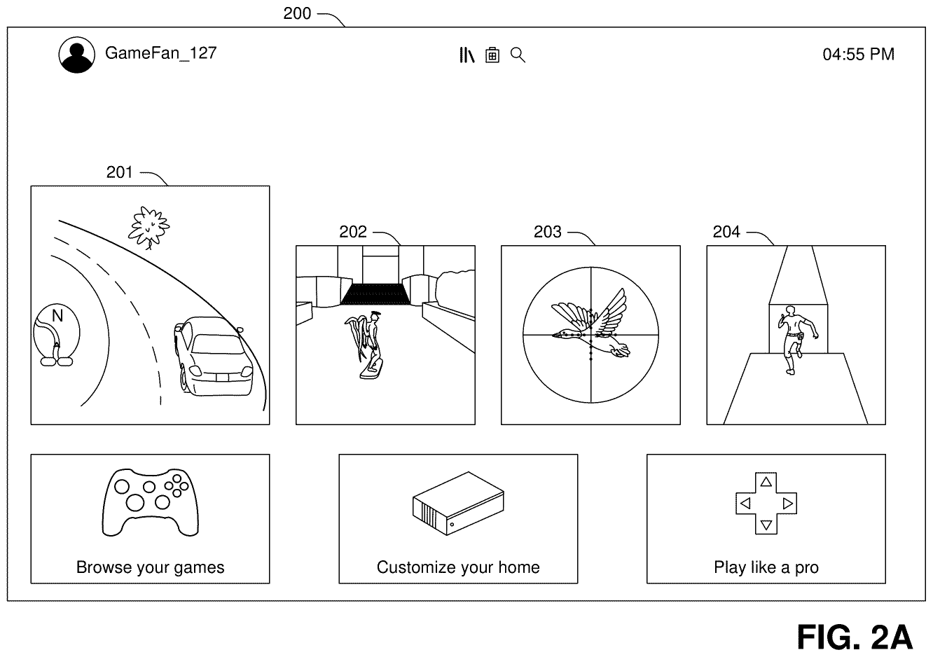

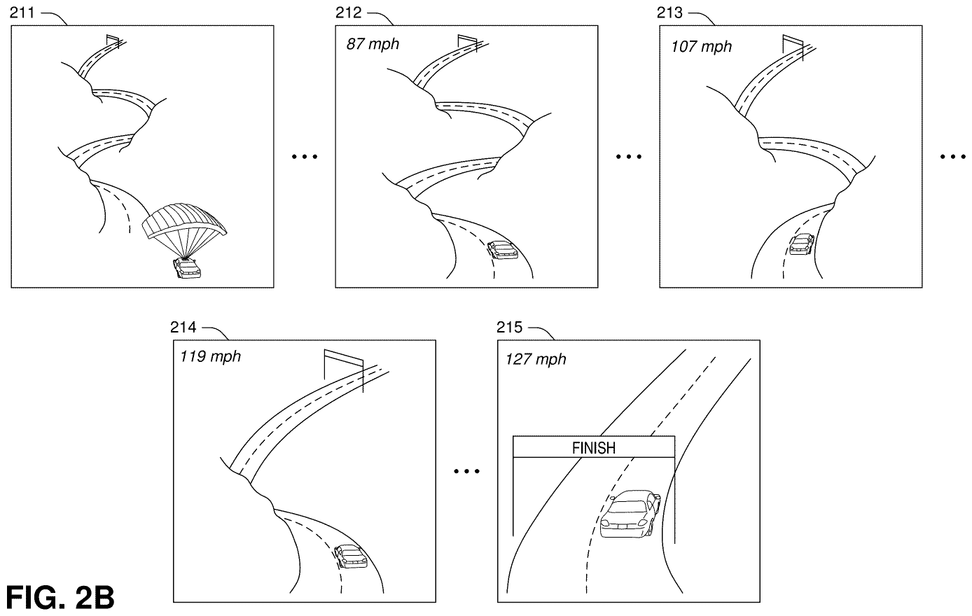

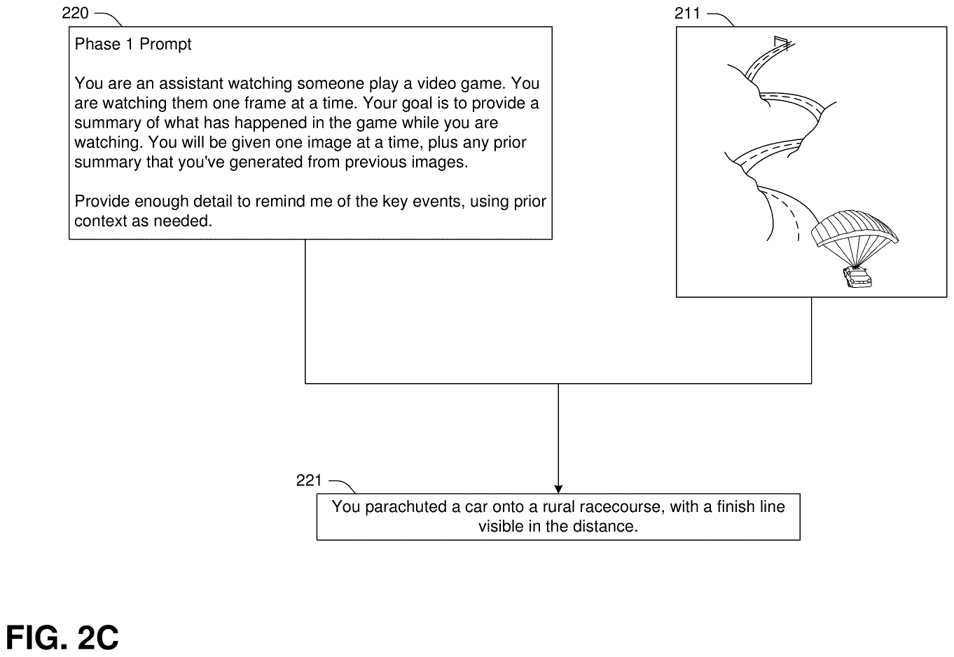

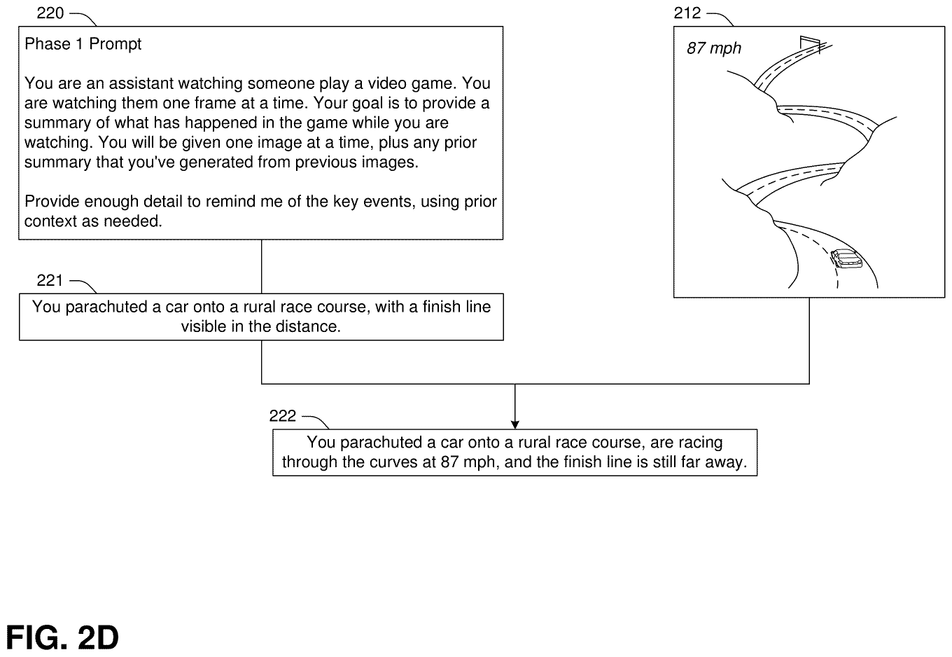

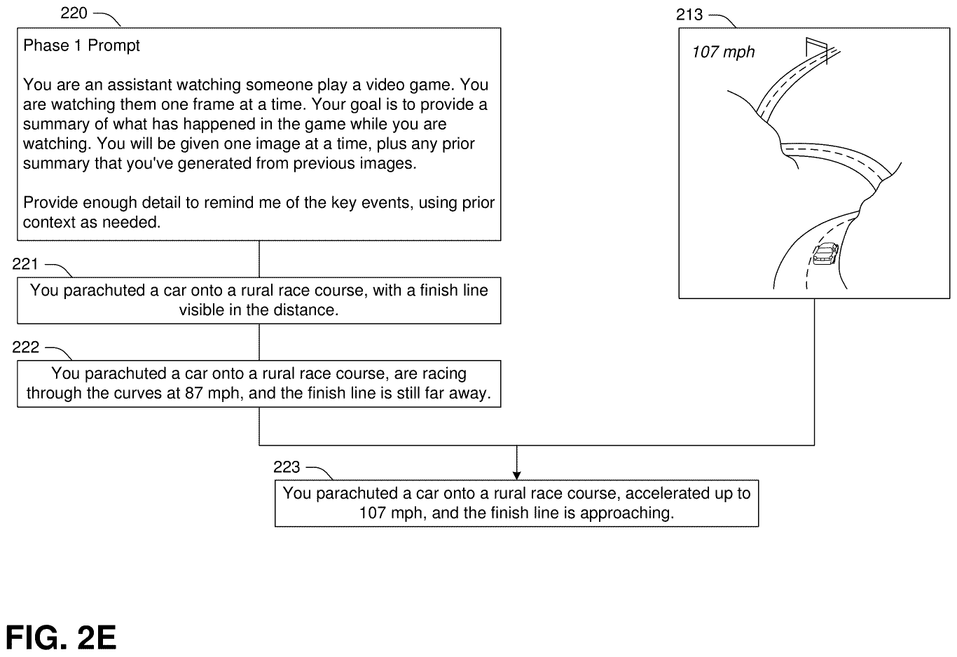

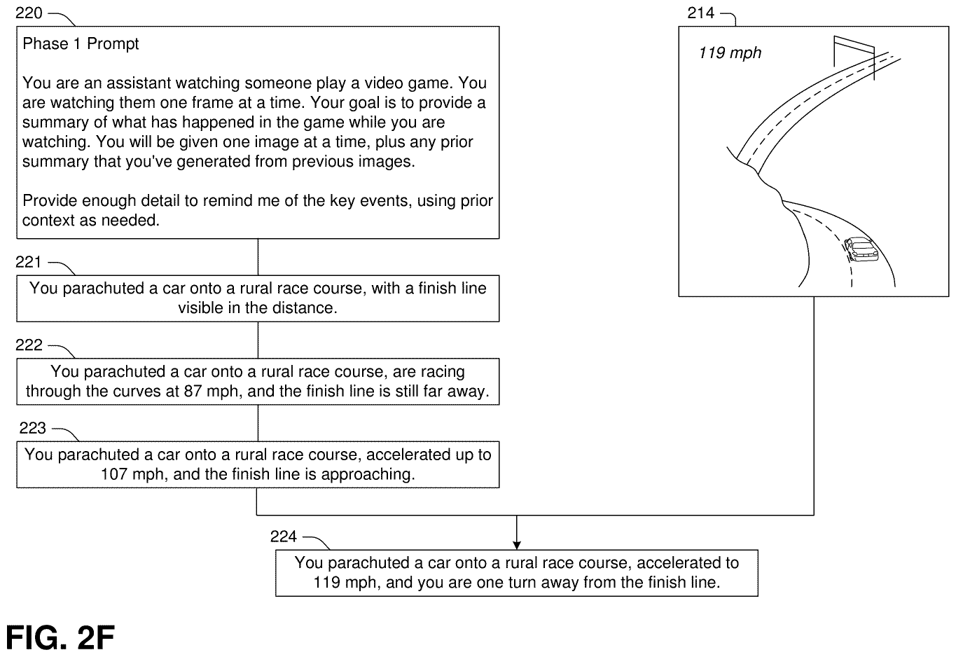

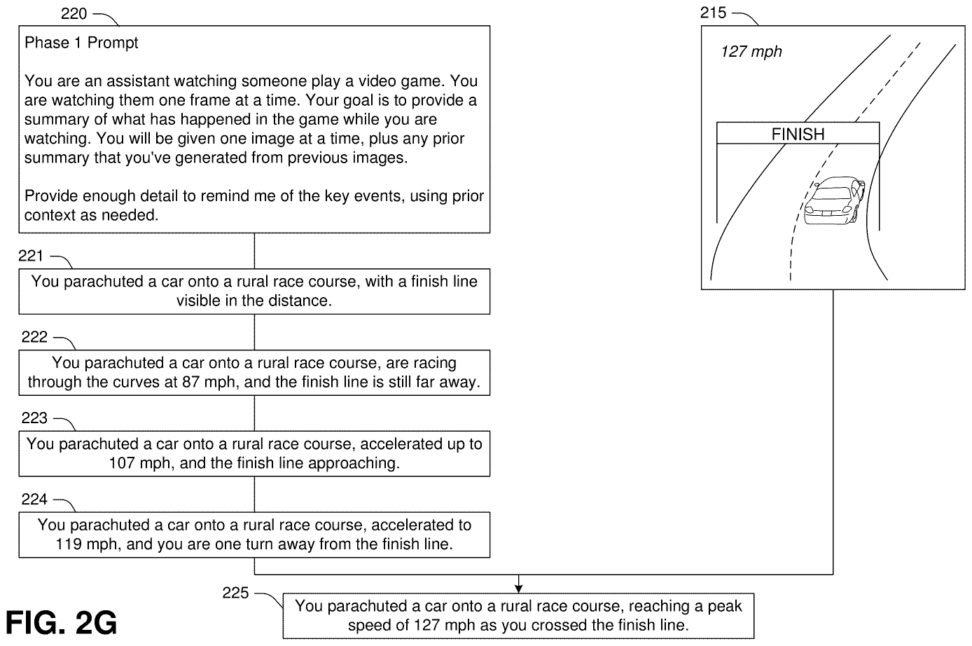

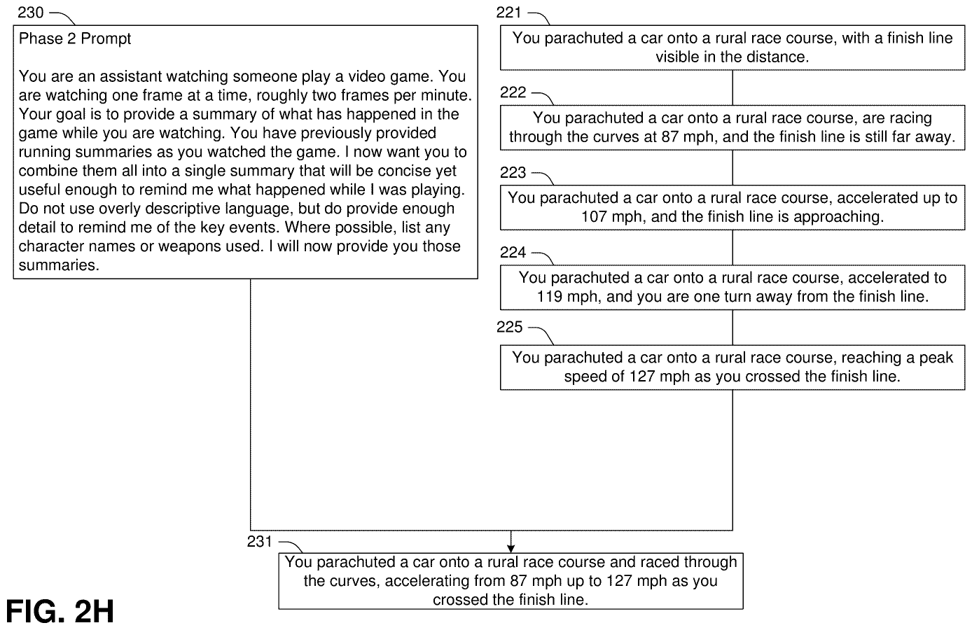

FIG. 2A illustrates an example home screen 200. When a video game player named “GameFan_127” turns on their device, activates a gaming application, and/or stops playing a given video game, home screen 200 can be displayed. The home screen includes various user interface elements, including a thumbnail 201 for a racing game, a thumbnail 202 for a fantasy game, a thumbnail 203 for a hunting game, and a thumbnail 204 for a sports game. The player can navigate the thumbnails via a directional button on a video game controller, a mouse, a keyboard, etc. The currently-selected thumbnail is expanded to convey to the user which thumbnail is currently selected, in this case thumbnail 201. The player can then click a button on the video game controller, keyboard, mouse, etc., to initiate a new session of the racing game.

FIG. 2B shows five video frames output by the racing game during gameplay during this first gaming session-frame 211, frame 212, frame 213, frame 214, and frame 215. Note that FIG. 2B uses ellipses to convey that not every frame can be shown in the figure. For the purposes of the following example, assume that the frames shown in FIG. 2B are captured as snapshots for subsequent summary generation, as discussed more below.

FIGS. 2C through 2G show examples of how individual frame narratives can be generated for frame 211, frame 212, frame 213, frame 214, and frame 215. Referring back to FIG. 1, frame 211, frame 212, frame 213, frame 214, and frame 215 can be obtained during capture platform data 104 of workflow 100. Then, updated frame narratives for each of these frames can be requested and saved as described below.

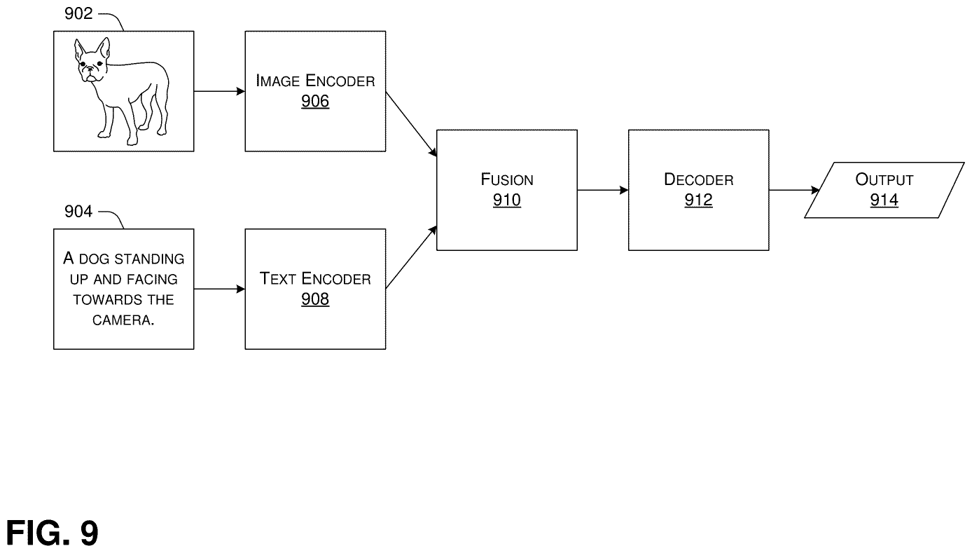

First, as shown in FIG. 20, a phase 1 prompt 220 is input to a generative machine learning model with video frame 211 to generate a first frame narrative 221. Next, in FIG. 2D, phase 1 prompt 220 is input to the generative machine learning model with video frame 212 and first frame narrative 221 to generate a second frame narrative 222. Thus, the generative machine learning model does not necessarily generate the second frame narrative based solely on video frame 212. Rather, a previously-generated frame narrative (frame narrative 221) is provided to the generative machine learning model as additional context for generating the subsequently-generated frame narrative 222.

The process can continue as described above, continuing to use previously-generated frame narratives describing previous frames to generate subsequent frame narratives describing subsequent frames. In FIG. 2E, phase 1 prompt 220 is input to the generative machine learning model with video frame 213, first frame narrative 221, and second frame narrative 222 to generate a third frame narrative 223. In FIG. 2F, phase 1 prompt 220 is input to the generative machine learning model with video frame 214, first frame narrative 221, second frame narrative 222, and third frame narrative 223 to generate a fourth frame narrative 224. In FIG. 2G, phase 1 prompt 220 is input to the generative machine learning model with video frame 215, first frame narrative 221, second frame narrative 222, third frame narrative 223, and fourth frame narrative 224 to generate a fifth frame narrative 225.

At this point, the video game session ends, and frame narratives have been generated for each of the video frames in the collected sequence of frames. Referring back to FIG. 1, session completion check 110 will evaluate to yes, and workflow 100 can proceed to produce overall narrative 112.

The overall narrative can be produced as shown in FIG. 2H. Here phase 2 prompt 230 is input to the generative machine learning model with first frame narrative 221, second frame narrative 222, third frame narrative 223, fourth frame narrative 224, and fifth frame narrative 225 as context. In response, the generative machine learning model can generate an overall narrative 231.

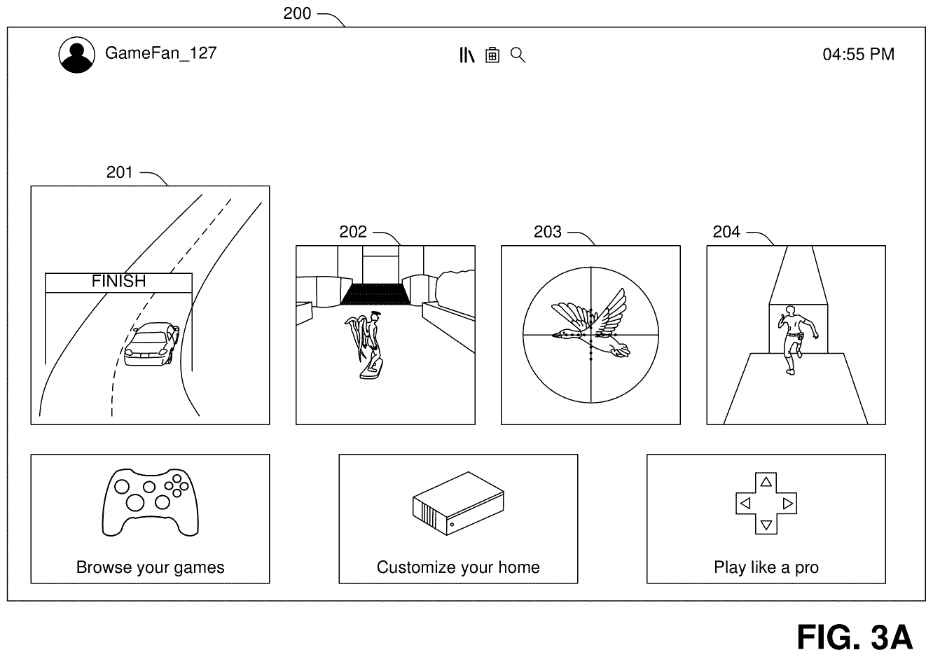

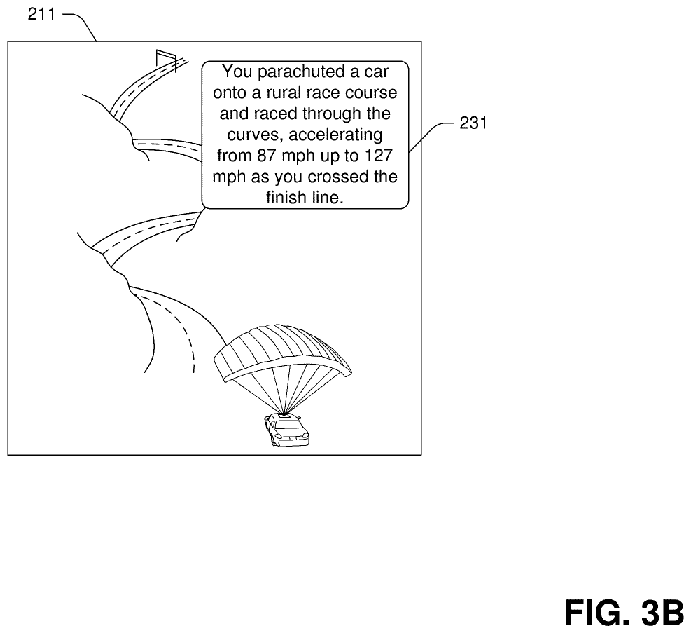

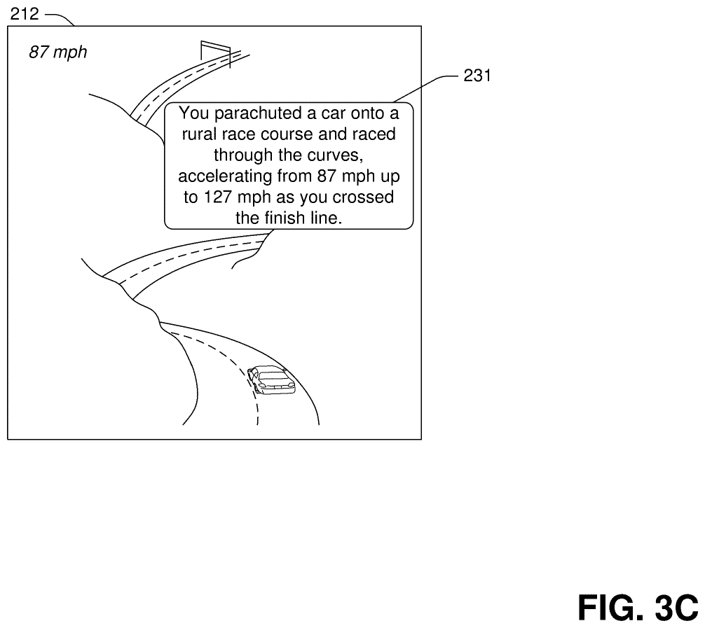

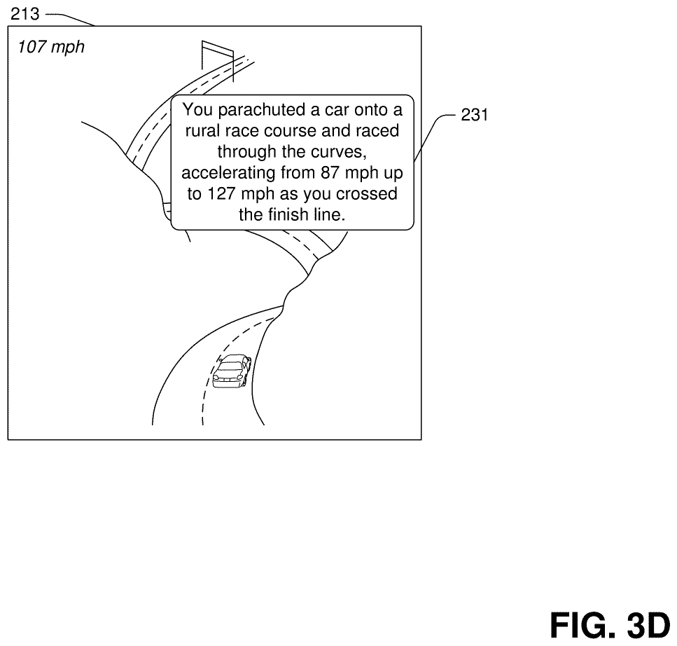

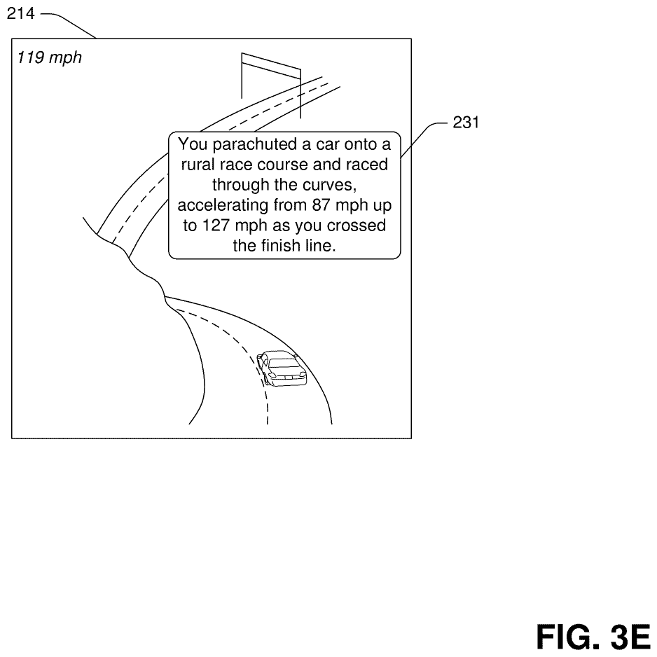

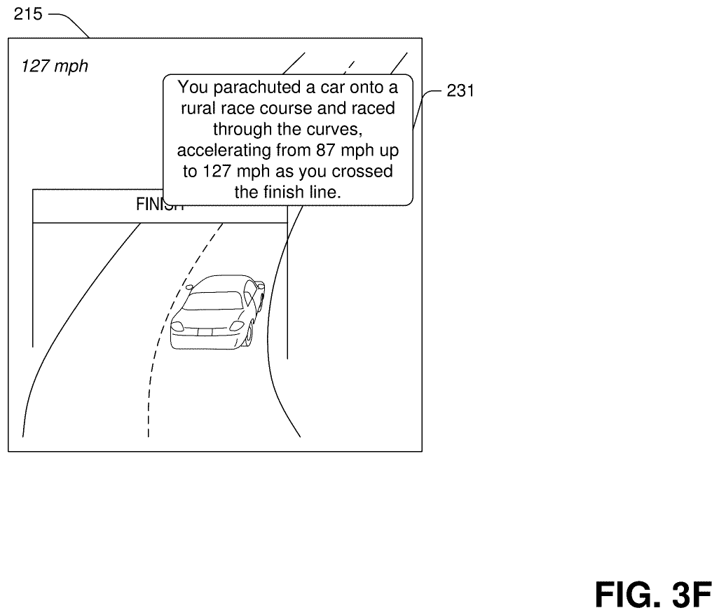

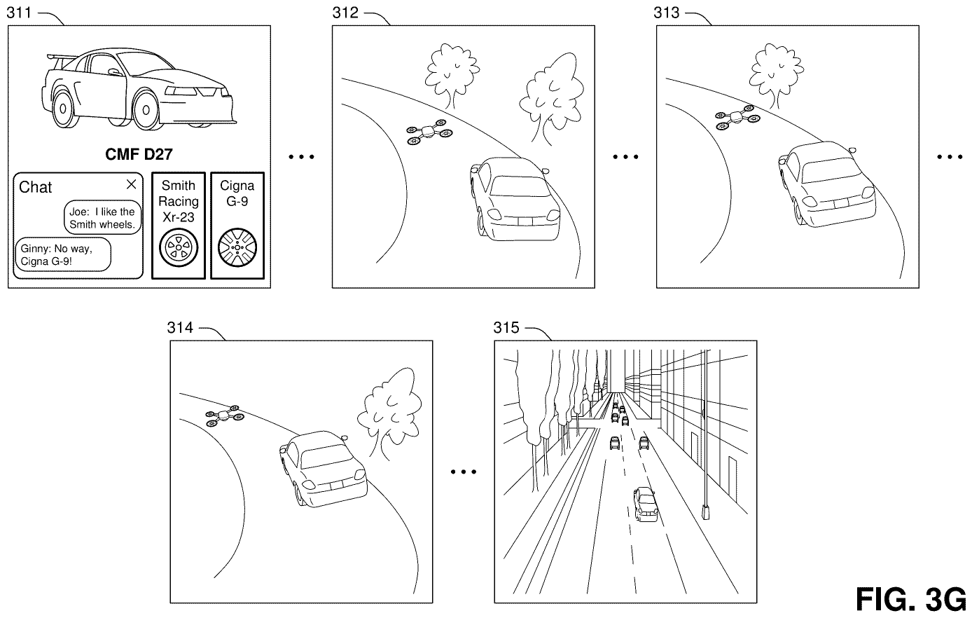

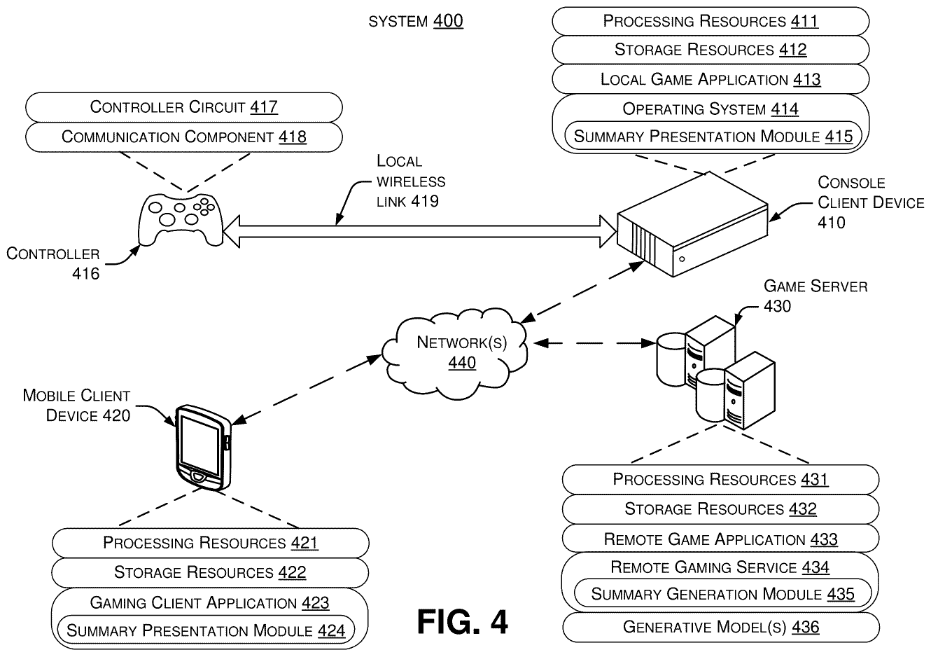

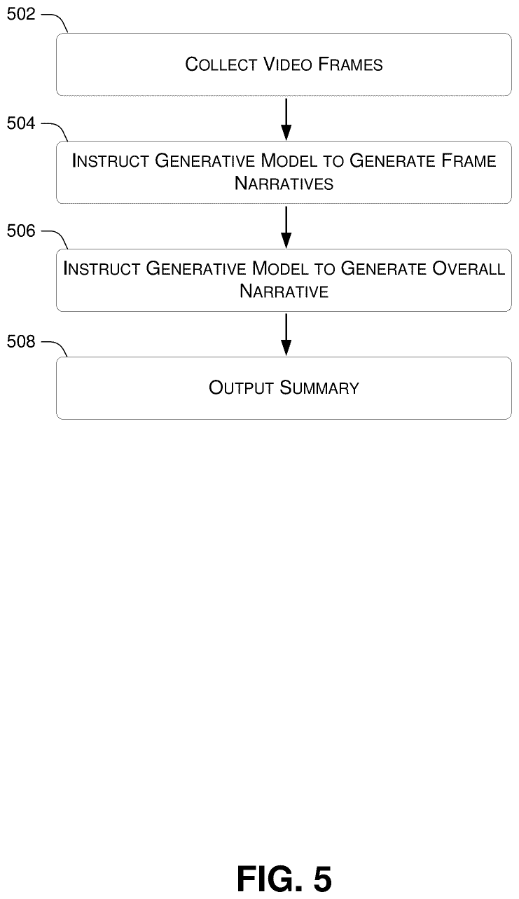

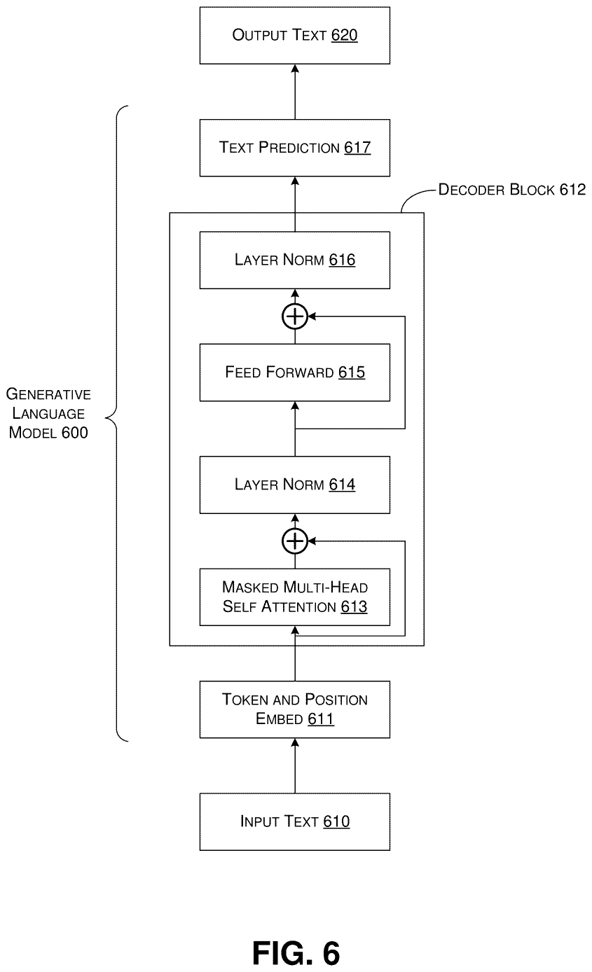

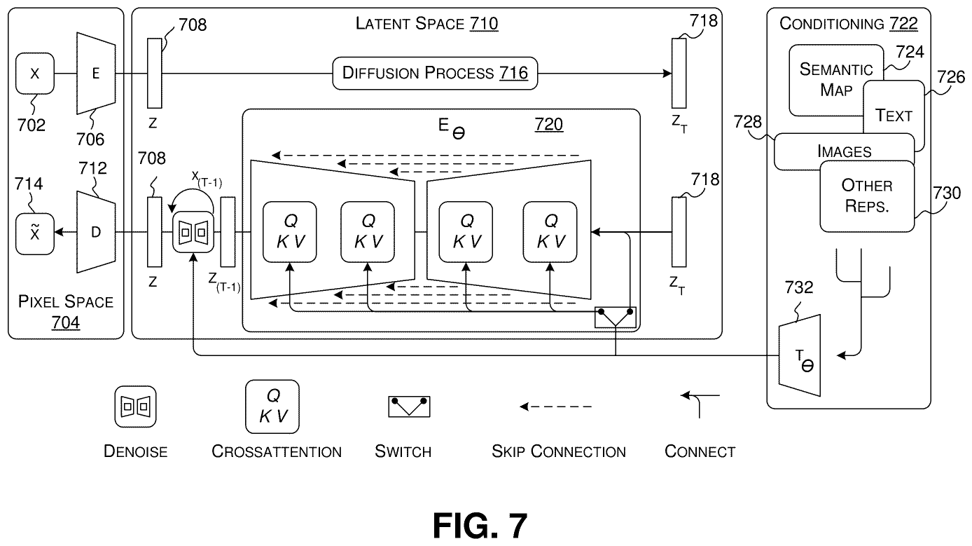

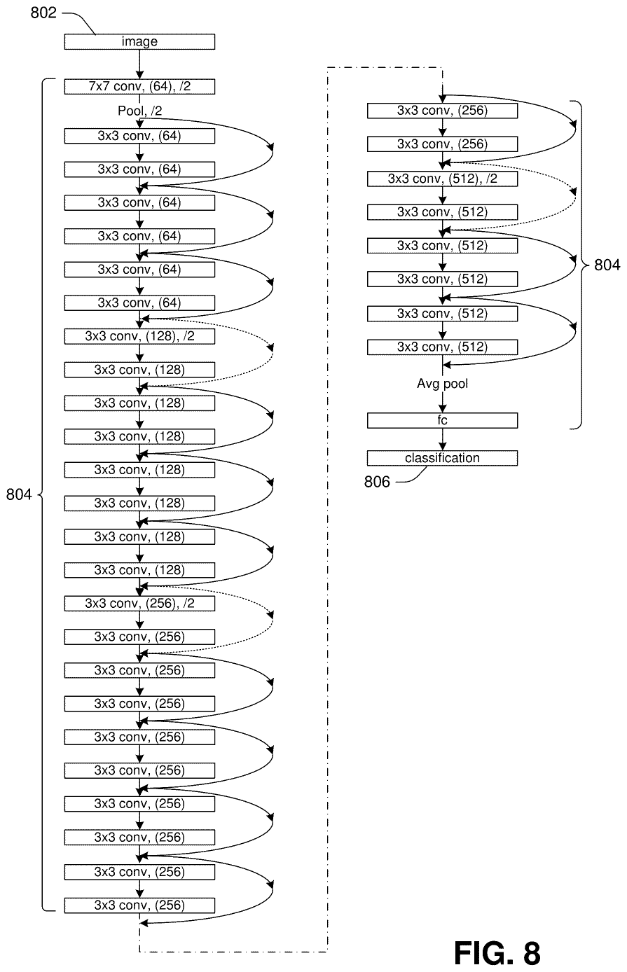

Assume that the video game player eventually decides to return and play the racing video game again at a later time. At this point, workflow 100 can proceed to output summary 114. FIGS. 3A-3F show an example user experience that can be provided in this regard.

FIG. 3A illustrates example home screen 200 the next time GameFan_127 turns on their device and/or returns to the homepage. Note that thumbnail 201 updated to reflect the result of the previous gaming session, with the car crossing the finish line. At this time, the racing game can begin loading, e.g., retrieving game state data from storage and loading the game state into memory. Concurrently, the player can be presented with a summary of the first video gaming session. The summary can include video frames from the previous gaming session as well as the overall narrative that was generated previously.

For example, the summary can be output as a sequence of the collected video frames together with the overall narrative. Here, FIG. 3B illustrates frame 211 shown concurrently with overall narrative 231, FIG. 3C illustrates frame 212 shown concurrently with overall narrative 231, FIG. 3D illustrates frame 213 shown concurrently with overall narrative 231, FIG. 3E illustrates frame 214 shown concurrently with overall narrative 231, and FIG. 3F illustrates frame 215 shown concurrently with overall narrative 231. The overall narrative describes the user's experienced from the previous gaming session in a concise manner, while individual video frames are shown to the user. While not shown in the FIGS., some implementations can also output the respective frame narratives in addition to and/or in place of the overall narrative. For instance, first frame narrative 221 can be output with frame 211, second frame narrative 222 can be output with frame 212, third frame narrative 223 can be output with frame 213, fourth frame narrative 224 can be output with frame 214, and fifth frame narrative 225 can be output with frame 215.

After presentation of one or more frames and narratives, the racing video game can be executed and the video game player can play the game for a second video gaming session. FIG. 3G shows five frames output by the racing game during the second session-frame 311, frame 312, frame 313, frame 314, and frame 315. Another summary can be generated for the second video gaming session and output to the user the next time they play the video game.

### Example System

The present concepts can be implemented in various technical environments and on various devices. FIG. 4 shows an example system 400 in which the present concepts can be employed, as discussed more below. As shown in FIG. 4, system 400 includes a console client device 410, a mobile client device 420, and a game server 430. Console client device 410, mobile client device 420, and server 430 are connected over one or more networks 440.

Console client device 410 can have processing resources 411 and storage resources 412, mobile client device 420 can have processing resources 421 and storage resources 422, and game server 430 can have processing resources 431 and storage resources 432. The devices of system 400 may also have various modules that function using the processing and storage resources to perform the techniques discussed herein, as discussed more below.

Console client device 410 can include a local game application 413 and an operating system 414. The local game application can execute using functionality provided by the operating system. The operating system can include a summary presentation module 415. The operating system can generate platform log data by collecting video frames, audio or haptic output, gaming inputs, etc. The platform log data can be transmitted to game server 430 as discussed more below.

The operating system can obtain control inputs from controller 416, which can include a controller circuit 417 and a communication component 418. The controller circuit can digitize inputs received by various controller mechanisms such as buttons or analog input mechanisms such as joysticks. The communication component can communicate the digitized inputs to the console client device over the local wireless link 419. The control interface module on the console can obtain the digitized inputs and provide them to the local application.

Mobile client device 420 can have a gaming client application 423. The gaming client application can send inputs from a touchscreen on the mobile client device and/or peripheral game controller to the server 430, and can also receive game outputs, such as video, chat, and/or audio streams, from the server(s) and output them via a display, loudspeaker, headset, etc. The gaming client application can include a summary presentation module 424.

Server 430 can include a remote game application 433, which can correspond to a streaming version of a video game. The server 430 can also have a remote gaming service 434, which can execute the remote game application and provide various support services, such as maintaining user accounts, tracking achievements, etc. The remote gaming service can also include a summary generation module 435 and one or more generative machine learning models 436. The remote gaming service 434 can generate platform log data in a manner such as that described above with respect to the operating system.

The summary generation module 435 on game server 430 can use generative model(s) 436 to generate summaries as described elsewhere herein. The summaries can be output via console client device 410 and/or mobile client device 420 when a player initiates a new video gaming session for output by the summary presentation modules.

Note also that other implementations are possible. For instance, console client device and/or mobile client device could generate summaries locally, using remote and/or local generative machine learning models. In addition, mobile client device 420 could execute a local instance of a gaming executable, and/or console client device could be employed for streaming gaming services provided by game server 430.

As a further point, note that a summary can be presented on a different device than the gaming session represented by that summary. For instance, a video game player could play a game on console client device 410 for a first session. Then, the same player could initiate a second session of that game on mobile client device 420 and view a summary of the first session on the mobile client device before playing a streaming version of the game via the remote gaming service 434. Likewise, that user could later view a summary of the second session via a display connected to the console client device, and so on.

In some cases, summary generation can also be distributed across different devices. For instance, a client device can have a local generative machine learning model that generates summaries of a video game played on that device. Periodically, the client device can send video frames to a server with a more performant (e.g., more parameters, larger context window, etc.) generative machine learning model that sends back one or more frame narratives to the client device. The client device can use the frame narratives generated by the remote generative machine learning model to ground subsequent generation of frame (or overall) narratives using the local generative model. This approach allows narrative generation to approximate the performance of using a larger generative machine learning model for all narrative generation using far less computational resources and bandwidth.

### Example Method

FIG. 5 illustrates an example computer-implemented method 500, consistent with some implementations of the present concepts. Method 500 can be implemented on many different types of devices, e.g., by one or more cloud servers, by a client device such as a laptop, tablet, or smartphone, or by combinations of one or more servers, client devices, etc.

Method 500 begins at block 502, where a sequence of video frames output by a video game are collected. For instance, a remote gaming service and/or operating system associated with a gaming platform can take snapshots of video frames output by a video game during a gaming session. In some cases, additional platform data such as audio output, haptic output, video game inputs, platform achievements, chat, etc., are also collected at block 502.

Method 500 continues at block 504, where a generative machine learning model is instructed to generate frame narratives for each of the collected video frames. For instance, a first prompt requesting generation of the frame narratives can be input to the generative machine learning model with each of the collected video frames. In some cases, previously-generated frame narratives are also provided with the first prompt as context for the generative machine learning model to employ when generating frame narratives for subsequent frames.

Method 500 continues at block 506, where the generative machine learning model is instructed to generate an overall narrative for the video gaming session. For instance, a second prompt can be input to the generative machine learning model with each of the frame narratives as context. In some implementations, the video frames themselves are not necessarily input to the generative machine learning model with the second prompt.

Method 500 continues at block 508, where a summary of the video gaming session is output to the video game player. For instance, the summary can include the overall narrative, the individual frame narratives, the collected video frames, etc. In some cases, the collected video frames are output in the same order that they were originally output by the video game, while concurrently displaying and/or narrating the overall narrative and/or individual frame narratives.

### ADDITIONAL IMPLEMENTATIONS

The examples introduced above provide an overview of the disclosed concepts. The following section describes additional details on the concepts described above.

As noted above, some implementations can collect video frames at a fixed rate, e.g., once every 30 seconds, once per minute, etc. In other cases, however, video frames can be collected selectively according to one or more criteria. For instance, referring back to FIG. 3G, note that frame 313, frame 314, and frame 315 are very similar—they all illustrate a car turning left on a road, with a drone flying near the car. On the other hand, frame 311 and frame 315 are very different than frame 313, frame 314, and frame 315.

Generally speaking, a summary of any of frame 313, frame 314, or frame 315 might be sufficient to adequately inform a video game player of a gaming session in which those frames were output. Thus, some implementations can select only one of these three frames for summarization. On the other hand, omitting a summary of frame 311 or frame 315 might be inadequate to inform the video game player, since these frames are very different from frame 313, frame 314, and frame 315.

One way to select which video frames are summarized involves computing a difference image across frames. For instance, a difference image computed by subtracting pixel values of frame 312 from pixel values of either frame 313 or frame 314 could result in an absolute value with a magnitude that is relatively low, due to the similarities of these images. On the other hand, a difference image computed by subtracting pixel values of frame 311 from pixel values of frame 312, frame 313, or frame 314 could result in a relatively high magnitude. Similarly, a difference image computed by subtracting pixel values of any of frame 312, frame 313, or frame 314 from frame 315 would likely also have a high magnitude.

Thus, one way to select which video frames are captured and/or employed for summary generation involves comparing video frames output during a given video gaming session to previously-output frames. If the difference between a current frame and a previous frame exceeds a threshold magnitude, the current frame can be stored for summary generation. If the difference is below the threshold, the frame can be discarded.

In other implementations, a computer vision model can be employed to determine whether a given frame is collected and/or summarized. For instance, some implementations can detect whenever a current frame includes an object that was not present in a previous frame, and then store the current frame. Thus, any time a new object appears in a given frame, that frame can be stored and employed for summary generation. In other cases, a list of specified objects is employed and only frames where an object on the list appears or disappears is stored and employed for summary generation. Thus, for example, in a racing game a finish line, a warning flag, a crash, etc., could be designated as objects on the list. On the other hand, trees, birds, houses, etc., could be omitted from the list. Thus, summary generation would be performed each time the current frame shows a finish line, warning flag, or crash that was not depicted in a previous frame, but the appearance of a new tree, bird, or house in a given frame would not necessarily result in that frame being summarized. The list of objects can be provided on a game-by-game basis, or in other cases can be provided for a game genre, e.g., the same list could be employed for multiple games in a given genre.

In other implementations, the video game itself can assist in determining which frames are summarized. For instance, the platform can provide an application programming interface that the video game can call to indicate that a significant event has occurred during gameplay. For instance, a racing game could call the application programming interface when the car reaches a new portion of a racetrack, finishes a race, passes another car to take first place, etc. Then, the platform can log the video frames that are output when the application programming interface is called and employ those frames for summary generation.

In still further implementations, prompts can be employed to indicate certain objects that the generative machine learning model should pay attention to when generating a frame narrative. For instance, a prompt for a racing game could instruct the generative machine learning model to look for warning flags, finish lines, accidents, etc. in a video frame. In other cases, the prompt can also specify objects to ignore, e.g., the prompt could instruct the generative machine learning model to ignore plants, animals, buildings that are not on the racecourse, etc., when generating a frame narrative.

In some cases, prompts can be manually written for individual video games and/or for video game genres. For instance, first and/or second prompts can be manually created for a given racing game, and other first and/or second prompts can be manually created for a given fantasy game. In other cases, a generative machine learning model can be prompted to create first and/or second prompts based on a description of a given game. Thus, for instance, a generative machine learning model might generate a first prompt for a racing game stating that warning flags, finish lines, and accidents should be summarized and that plants, animals, and/or building should be ignored. The generative machine learning model might generate a different first prompt for a game that involves farming stating that plants and animals should be summarized, while clouds and buildings should be ignored.

In still further cases, the prompts could be provided with example images and associated descriptions of game-specific objects such as in-game characters, enemies, locations, etc. This approach allows the generative machine learning model to identify these objects in the video frames and then use the descriptions for summary generation. In further implementations, subtitles or other text displayed by a game can be extracted and provided to the generative machine learning model.

In still further implementations, certain information can be redacted when generating a summary. For instance, consider a scenario where a given video game player might allow another player to start playing a video game from a save state that they created. Here, the first player may be willing to allow the second player to play the game from where the first player left off, the first player but may not wish to share certain sensitive information that may have appeared during the previous gaming session.

For instance, referring back to FIG. 3G, frame 311 includes some text describing wheels (Smith Racing Xr-23 and Cigna G-9), but also includes a chat session between a user named Joe and another user named Ginny. Joe or Ginny may prefer that other users do not see the content of their chat. Thus, some implementations can redact the chat content when generating a summary of frame 311.

One way to redact certain content involves training a computer vision model to detect objects such as chat windows and then directly overwriting the pixels of the detected objects. Another way to do so involves providing in-context examples to a generative machine learning model. For instance, one or more video frames having user interface elements (such as the wheel icons in frame 311) can be input as negative examples of sensitive content, and one or more other video frames having chat content can be input as positive examples of sensitive content. The generative machine learning model can use generative image capabilities to remove the chat content from frame 311 prior to outputting frame 311 in a subsequent summary, potentially inpainting the chat area consistently with the rest of the background of the frame.

In some implementations, different summaries can be generated for different video gaming sessions. For instance, a first summary can be generated for a first video gaming session and a second summary can be generated for a second video gaming session. In some cases, there may be different save states associated with each session, e.g., a first save state indicating the state of the video game at the end of the first session, and a second save state indicating the state of the video game at the end of the second session.

When a video game player selects a given save state, the corresponding summary can be retrieved and output. For instance, each save state can have a corresponding save state timestamp indicating when that save state was created, e.g., at the end of a given gaming session. Each summary can also have a corresponding summary timestamp indicating a timeframe associated with that summary. The summary that is presented to a user can be selected based on the save state timestamps and summary timestamps, e.g., by finding the summary timestamp that is closest to the save state timestamp of a retrieved save state. In other cases, integers, globally unique identifiers, or other values can be used to map summaries to corresponding save states.

In still further implementations, multiple video clips from a video gaming session can be stored. One or more frames from each clip can be employed for generating frame narratives. Then, when the summary is presented to the user, the corresponding video clips can be replayed to the user while outputting frame narratives of frames taken from the clips, and/or an overall narrative. This allows a moving video summary experience to be provided while still using static images for summary generation.

As a further point, the disclosed concepts can also be performed to generate summaries of three-dimensional and/or augmented or virtual reality video games. For instance, snapshots of frames rendered on a virtual reality headset or smart glasses can be employed for summary generation. As another example, the disclosed concepts can also be employed for applications other than video games, e.g., a summary of a session on a flight simulator could be generated as described above.

### Technical Effect

As noted previously, one way to summarize a previous video gaming session involves using a single snapshot from that session to remind a video game player of where they left off in a game. However, this approach can be insufficient to adequately inform the video game player of their previous video gaming experience.

Another approach could involve comprehensive summarization of a video gaming session using a generative machine learning model. For instance, video frames could be input at a high rate to a generative machine learning model with a request to summarize the video. However, this approach is technically infeasible due to context window limitations, e.g., many generative machine learning models lack sufficiently large context windows to process a high-rate stream of video frames. Moreover, even assuming the context windows limitations could be overcome, it could nevertheless involve significant processing, bandwidth, memory, and storage resources to summarize a high-rate video stream.

The disclosed implementations can employ an approach that uses relatively few video frames to generate a summary of a video gaming session. As noted above, a first phase prompt can be input to a generative machine learning model with a single frame output by a video game to generate frame narrative for that frame. Assuming, for example, one video frame is summarized every 30 seconds for a video game with a 60 frames-per-second frame rate, only one out of every 1800 frames is summarized. This achieves a significant cost savings in terms of processing, bandwidth, memory, and storage compared to approaches that attempt to summarize high-rate streams of video data. In some cases, summary generation can even be performed at runtime, e.g., generating a summary of an ongoing video gaming session as the game is played. As a result, the summary can be immediately available for output once that session ends.

As another point, consider an implementation that inputs preceding frames as context when generating frame narratives for a current frame. Generally, video frames consume a large amount of data, e.g., a high resolution video frame might have far more data than a textual narrative describing that video frame. Thus, the disclosed technique of using frame narratives for previously-summarized frames (rather than the previous frames themselves) as context for summarizing subsequent frames results in additional savings of processing, bandwidth, memory, and/or storage resources. Said another way, the sequence of frame narratives serves as a running commentary describing previously-summarized frames that is sufficient to ground summary generation for subsequent frames in a manner that results in accurate summaries.

Similarly, recall that the overall narrative generation can be performed without inputting video frames to the generative machine learning model at all. In other words, the sequence of individual frame narratives is sufficient context for the model to generate an accurate summary of an entire video gaming session. Thus, each video frame only needs to be processed by the generative machine learning model once, resulting in additional processor, bandwidth, memory, and/or storage savings. Moreover, the summary itself is relatively compact, e.g., relatively few selected frames from a given session together with one or more textual narratives. Thus, the summary can be transmitted to a given client device using relatively little bandwidth while consuming very little memory and/or storage.

As a final point, another approach for summarizing a video game session involves extensive game integration. For instance, a video game could make extensive use of a software development kit provided by a platform, and create comprehensive game logs describing events that occur in a given gaming session. While this approach can allow for very thorough and accurate summary generation, it also necessarily involves significant refactoring of game code to use the those application programming interfaces. Further, this approach would be even more difficult for legacy games that are no longer under active development.

### Example Decoder-Based Generative Language Model

FIG. 6 illustrates an exemplary generative language model 600 (e.g., a transformer-based decoder) that can be employed using the disclosed implementations. (Radford, et al., “Improving language understanding by generative pre-training,” 2018). Generative language model 600 is an example of a machine learning model that can be used to perform one or more natural language processing tasks that involve generating text, as discussed more below. For the purposes of this document, the term “natural language” means language that is normally used by human beings for writing or conversation.

Generative language model 600 can receive input text 610, e.g., a prompt from a user or a prompt generated automatically by machine learning using the disclosed techniques. For instance, the input text can include words, sentences, phrases, or other representations of language. The input text can be broken into tokens and mapped to token and position embeddings 611 representing the input text. Token embeddings can be represented in a vector space where semantically-similar and/or syntactically-similar embeddings are relatively close to one another, and less semantically-similar or less syntactically-similar tokens are relatively further apart. Position embeddings represent the location of each token in order relative to the other tokens from the input text.

The token and position embeddings 611 are processed in one or more decoder blocks 612. Each decoder block implements masked multi-head self-attention 613, which is a mechanism relating different positions of tokens within the input text to compute the similarities between those tokens. Each token embedding is represented as a weighted sum of other tokens in the input text. Attention is only applied for already-decoded values, and future values are masked. Layer normalization 614 normalizes features to mean values of 0 and variance to 1, resulting in smooth gradients. Feed forward layer 615 transforms these features into a representation suitable for the next iteration of decoding, after which another layer normalization 616 is applied. Multiple instances of decoder blocks can operate sequentially on input text, with each subsequent decoder block operating on the output of a preceding decoder block. After the final decoding block, text prediction layer 617 can predict the next word in the sequence, which is output as output text 620 in response to the input text 610 and also fed back into the language model. The output text can be a newly-generated response to the prompt provided as input text to the generative language model.

Generative language model 600 can be trained using techniques such as next-token prediction or masked language modeling on a large, diverse corpus of documents. For instance, the text prediction layer 617 can predict the next token in a given document, and parameters of the decoder block 612 and/or text prediction layer can be adjusted when the predicted token is incorrect. In some cases, a generative language model can be pretrained on a large corpus of documents. Then, a pretrained generative language model can be tuned using a reinforcement learning technique such as reinforcement learning from human feedback (“RLHF”).

### Example Generative Image Model

FIG. 7 illustrates an example generative image model 700. For instance, generative image model 700 can be implemented as a Stable Diffusion model (Rombach, et al., “High-Resolution Image Synthesis with Latent Diffusion Models,” Proceedings of the IEEE/CVF Conference on Computer Vision and Pattern Recognition, 2022), in which an image 702 (X) in pixel space 704 (e.g., red, green, blue) is encoded by an encoder 706 (E) into a representation 708 (Z) in a latent space 710. A decoder 712 (D) is trained to decode the latent representation Z to produce a reconstructed image 714 (X~) in the pixel space. For instance, the encoder can be trained (with the decoder) as a variational autoencoder using a reconstruction loss term with a regularization term.

In the latent space 710, a diffusion process 716 adds noise to obtain a noisy representation 718 (ZT). A denoising component 720 (Ee) is trained to predict the noise in the compressed latent image ZT. The denoising component can include a series of denoising autoencoders implemented using UNet 2D convolutional layers.

The denoising can involve conditioning 722 on other modalities, such as a semantic map 724, text 726, images 728, or other representations 730 which can be processed to obtain an encoded representation 732 (To). For instance, text can be encoded using a text encoder (e.g., BERT, CLIP, etc.) to obtain the encoded representation. This encoded representation can be mapped to layers of the denoising component using cross-attention. The result is a text-conditioned latent diffusion model that can be employed to generate images conditioned on text inputs. To train a model such as CLIP, pairs of images and captions can be obtained from a dataset to encode both the images and captions, and the encoder can be trained to represent pairs of images and captions with similar embeddings.

Generative image model 700 can be employed for text to image generation, where an image is generated from a text prompt. Text prompts can be provided by users or generated automatically by machine learning using the disclosed techniques. In other cases, generative image model 700 can be employed for image-to-image mode, where an image is generated using an input image as well as a user or machine-generated text prompt. Generative image model 700 can also be employed for inpainting, where parts of an image are masked and remain fixed while the rest of the image is generated by the model, in some cases conditioned on a user or machine-generated text prompt.

In some cases, generative image model 700 can be guided by a separate network, such as a ControlNet (Zhang, et al., “Adding Conditional Control to Text-to-Image Diffusion Models,” Proceedings of the IEEE/CVF International Conference on Computer Vision, 2023). For instance, a ControlNet can guide the generative model to produce an image that preserves certain aspects of another image, e.g., the spatial layout and salient features of an image prior. A ControlNet can be implemented by locking the parameters of generative image model 700, cloning the model into another copy. The copy is connected to the original model with one or more zero convolutional layers which are then optimized with the parameters of the copy. For instance, the ControlNet can be trained to preserve edges, lines, boundaries, human poses, semantic segmentations, etc. from an image. A ControlNet can also be trained to preserve depth relationships of a user-identified image using a depth map obtained from the user-identified image, etc. The outputs of a ControlNet can be added to connections within the denoising layer. Thus, the generative image model can produce images that are conditioned not only on text, but also aspects of another image.

Generative image model 700 can implement a number of different modes. In a text-to-image mode, an image is generated from a given text prompt. In an image-to-image mode, an image is generated from a text prompt and an input image, and the generated image retains features of the input image while introducing new elements or styles consistent with the prompt. In inpainting/outpainting mode, the processing is similar to the image-to-image mode, but an image mask is used to determine which parts of the image are fixed to match the input image. The rest of the image is generated in a way that is consistent with the fixed parts of the image. Note that the term “inpainting,” as used herein, includes filling in parts of a given image whereas “outpainting” refers to extending an image outward.

### Example Computer Vision Model

FIG. 8 illustrates a particular example of a neural network model for computer vision. For instance, FIG. 8 shows an image 802 being classified by a computer vision model 804 to determine an image classification 806, where the computer vision model can be a ResNet model (He, et al., “Deep Residual Learning for Image Recognition,” in Proceedings of the IEEE Conference on Computer Vision and Pattern Recognition, 2016, pp. 770-778). The computer vision model can include a number of convolutional layers, most of which have 3×3 filters. Generally, given the same output feature map size, the convolutional layers have the same number of filters (e.g., 64, 128, 246, 412). If the feature map size is halved by a given convolutional layer (as shown by “/2” in FIG. 8), then the number of filters can be doubled to preserve the time complexity across layers.

After the image has been processed using a series of convolutional layers, the image is processed in a global average pooling layer. The output of the pooling layer is processed with a fully-connected layer with softmax. The fully-connected layer (e.g., one thousand-way) can be used to determine a classification, e.g., an object category of an object in image 802.

The respective layers within computer vision model 804 can have shortcut connections which perform identity operations:

y=F(x,{Wᵢ})+x (1)

where x and y are the input and output vectors of the layers involved and F(x, {Wᵢ}) represents the residual mapping learned by the model. In some connections the dimensions increase across layers (shown as dotted lines in FIG. 8). In these cases, the following projection can be employed to match the dimensions via 1×1 convolutions:

y=F(x,{Wᵢ})+Wₛx (2)

In some implementations, computer vision model 804 can be pretrained on a large dataset of images, such as ImageNet. Such a general-purpose image database can provide a vast number of training examples that allow the model to learn weights that allow generalization across a range of object categories. Said another way, computer vision model 804 can be pretrained in this fashion.

After pretraining, computer vision model 804 can be tuned on another, smaller dataset for categories of interest. For instance, tuning datasets can be provided for specific groups of users. As one example, software developers might tend to use UML (Unified Modeling Language) diagrams or directed acyclic graphs, whereas other users might tend to use conventional flow charts, and thus different computer vision models can be tuned for these different sets of users. As another example, social media users might tend to post images of things in their home, such as pets or furniture, whereas business users might tend to post images of graphs, scatterplots, pie charts, etc.

### Example Vision Language Model

FIG. 9 shows an example vision language model 900 that can process an input image 902 and/or a text input 904. The input image is processed using an image encoder 906 (e.g., based on computer vision model 804) and the text input is processed using a text encoder 908. The image encoder and text encoder produce encodings (e.g., vector embeddings) representing the input image and text input, respectively. A fusion process 910 can fuse the encodings using techniques such as attention, dot product, etc. A decoder 912 can decode the fused encodings to produce an output 914. In some implementations, vision language model 900 can be a CLIP model (Radford, et al., “Learning transferable visual models from natural language supervision,” International conference on machine learning, July 2021, pp. 8748-8763, PmLR).

In some implementations, the image encoder can also be based on a transformer architecture such as a Vision Transformer (Dosovitskiy, et al., “An Image is Worth 16×16 Words: Transformers for Image Recognition at Scale,” Jun. 3, 2021, arXiv preprint arXiv: 2010.11929v2). The text encoder 908 can be based on a transformer architecture such as BERT or GPT. In other cases, an “early fusion” approach can employ a shared encoder that processes sequences of text and image tokens using a single encoder that determines embeddings for each text or image token. (Chameleon. Team C, “Chameleon: Mixed-Modal Early-Fusion Foundation Models,” 2024, arXiv preprint, arXiv: 2404.09818).

The vision language model 900 can be trained using approaches such as contrastive learning, where the training data includes pairs of text and images and the model is trained to determine whether a given text sample matches a corresponding image sample. In this manner, the image encoder 906 and the text encoder 908 can be trained to generate similar embeddings for text and images that represent similar concepts (e.g., the word “bear” and an image of a bear). Other approaches include masked image modeling and/or masked language modeling and image-text modeling.

The output 914 can characterize an image. For instance, the output can answer a visual question, caption the image, etc. The output can also identify detected objects, classify detected objects, perform image segmentation, etc. In some cases, the vision language model 900 can determine a label for an object in an input image. The labels can identify a category of the object (e.g., “bed” or “sofa”), a description of the object (e.g., “a queen-sized bed with blue bedding and a headboard”), or even specify information such as a brand of the object (e.g., “ABC brand queen size platform bed”), etc. The output can also specify relationships between detected objects, e.g., “the bear is riding the unicycle in the circus ring,” etc.

### Device Implementations

As noted above with respect to FIG. 4, system 400 includes several devices, including a client device 410, a client device 420, and one or more server(s) 430. As also noted, not all device implementations can be illustrated, and other device implementations should be apparent to the skilled artisan from the description above and below.

The term “device,” “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore and, when executed, can cause a processor to perform acts. The term “system” as used herein can refer to a single device, multiple devices, etc.

Storage resources can be internal or external to the respective devices with which they are associated. The storage resources can include any one or more of volatile or non-volatile memory, hard drives, solid state drives, flash storage devices, and/or optical storage devices (e.g., CDs, DVDs, etc.), among others. As used herein, the terms “computer-readable media” and “computer-readable medium” can include signals. In contrast, the terms “computer-readable storage media” and “computer-readable storage medium” excludes signals. Computer-readable storage media includes “computer-readable storage devices.” Examples of computer-readable storage devices include volatile storage media, such as RAM, and non-volatile storage media, such as hard drives, optical discs, solid state drives, flash memory, etc.

In some cases, the devices are configured with a general-purpose hardware processor and storage resources. Processors and storage can be implemented as separate components or integrated together as in computational RAM. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), neural processing units (NPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.), microphones, etc. Devices can also have various output mechanisms such as printers, monitors, speakers, etc.

Also note that the devices described herein can function in a stand-alone or cooperative manner to implement the described techniques. For example, the methods and functionality described herein can be performed on a single computing device and/or distributed across multiple computing devices that communicate over network(s) 440. Without limitation, network(s) 440 can include one or more local area networks (LANs), wide area networks (WANs), the Internet, and the like.

### Additional Examples

Various examples are described above. Additional examples are described below. One example includes a computer-implemented method, comprising collecting a sequence of video frames that are output during a video game session involving a video game player playing a video game, instructing a generative machine learning model to generate respective frame narratives describing individual video frames from the sequence, instructing the generative machine learning model to generate an overall narrative describing the video game session based at least on the respective frame narratives, and outputting a summary of the video game session to the video game player, the summary including the overall narrative and the individual video frames.

Another example can include any of the above and/or below examples where instructing the generative machine learning model to generate the respective frame narratives comprises inputting a first prompt to the generative machine learning model with the individual video frames.

Another example can include any of the above and/or below examples where the method further comprises sequentially inputting previously-generated frame narratives to the generative machine learning model with instructions to generate subsequent frame narratives based at least on the first prompt and the previously-generated frame narratives.

Another example can include any of the above and/or below examples where instructing the generative machine learning model to generate the overall narrative comprises inputting a second prompt to the generative machine learning model with the individual frame narratives.

Another example can include any of the above and/or below examples where the second prompt is input to the generative machine learning model without the individual video frames.

Another example can include any of the above and/or below examples where the method further comprises periodically collecting the video frames at runtime at a specified frame collection rate.

Another example can include any of the above and/or below examples where the method further comprises selectively collecting the video frames at runtime based on one or more criteria.

Another example can include any of the above and/or below examples where the selectively collecting is based on differences in video frames.

Another example can include any of the above and/or below examples where the selectively collecting is based on an application programming interface call by the video game.

Another example includes a system comprising a processor and a storage medium storing instructions which, when executed by the processor, cause the system to collect a sequence of video frames that are output during a video game session involving a video game player playing a video game, instruct a generative machine learning model to generate respective frame narratives describing individual video frames from the sequence, instruct the generative machine learning model to generate an overall narrative describing the video game session based at least on the respective frame narratives, and output a summary of the video game session to the video game player, the summary including the overall narrative and the individual video frames.

Another example can include any of the above and/or below examples where the instructions, when executed by the processor, cause the system to redact sensitive information from the video frames prior to inputting the video frames to the generative machine learning model.

Another example can include any of the above and/or below examples where the sensitive information comprises on-screen chat.

Another example can include any of the above and/or below examples where the instructions, when executed by the processor, cause the system to output the summary in response to the video game player initiating a subsequent session.

Another example can include any of the above and/or below examples where the instructions, when executed by the processor, cause the system to store multiple summaries associated with different save points, receive user input from the video game player selecting a particular save point, and select a particular summary to present to the video game player based at least on the particular save point.

Another example can include any of the above and/or below examples where the instructions, when executed by the processor, cause the system to store summary timestamps associated with individual summaries, store save point timestamps associated with the different save points, and select the particular summary by matching a particular save point timestamp associated with the particular save point to a particular summary timestamp associated with the particular summary.

Another example can include any of the above and/or below examples where the instructions, when executed by the processor, cause the system to provide the generative machine learning model with context describing the game when instructing the generative machine learning model to generate the respective frame narratives.

Another example can include any of the above and/or below examples where the instructions, when executed by the processor, cause the system to instruct the generative machine learning model to pay attention to certain types of objects in the individual video frames.

Another example can include any of the above and/or below examples where the instructions, when executed by the processor, cause the system to instruct the generative machine learning model to ignore other types of objects in the individual video frames.

Another example can include any of the above and/or below examples where the instructions, when executed by the processor, cause the system to instruct the generative machine learning model to generate a prompt and input the generated prompt to the generative machine learning model to generate the respective frame narratives.

Another example includes a computer-readable storage medium storing instructions which, when executed by a processing device, cause the processing device to perform acts comprising collecting a sequence of video frames that are output during a video game session involving a video game player playing a video game, instructing a generative machine learning model to generate respective frame narratives describing individual video frames from the sequence, instructing the generative machine learning model to generate an overall narrative describing the video game session based at least on the respective frame narratives, and outputting a summary of the video game session to the video game player, the summary including the overall narrative and the individual video frames.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method, comprising:
collecting a sequence of video frames that are output during a video game session involving a video game player playing a video game;
instructing a generative machine learning model to generate respective frame narratives describing individual video frames from the sequence;
instructing the generative machine learning model to generate an overall narrative describing the video game session based at least on the respective frame narratives; and
outputting a summary of the video game session to the video game player, the summary including the overall narrative and the individual video frames.

2. The computer-implemented method of claim 1, wherein instructing the generative machine learning model to generate the respective frame narratives comprises inputting a first prompt to the generative machine learning model with the individual video frames.

3. The computer-implemented method of claim 2, further comprising:
sequentially inputting previously-generated frame narratives to the generative machine learning model with instructions to generate subsequent frame narratives based at least on the first prompt and the previously-generated frame narratives.

4. The computer-implemented method of claim 3, wherein instructing the generative machine learning model to generate the overall narrative comprises inputting a second prompt to the generative machine learning model with the individual frame narratives.

5. The computer-implemented method of claim 4, wherein the second prompt is input to the generative machine learning model without the individual video frames.

6. The computer-implemented method of claim 1, further comprising:
periodically collecting the video frames at runtime at a specified frame collection rate.

7. The computer-implemented method of claim 1, further comprising:
selectively collecting the video frames at runtime based on one or more criteria.

8. The computer-implemented method of claim 7, the selectively collecting being based on differences in video frames.

9. The computer-implemented method of claim 7, the selectively collecting being based on an application programming interface call by the video game.

10. A system comprising:
a processor; and
a storage medium storing instructions which, when executed by the processor, cause the system to:
collect a sequence of video frames that are output during a video game session involving a video game player playing a video game;
instruct a generative machine learning model to generate respective frame narratives describing individual video frames from the sequence;
instruct the generative machine learning model to generate an overall narrative describing the video game session based at least on the respective frame narratives; and
output a summary of the video game session to the video game player, the summary including the overall narrative and the individual video frames.

11. The system of claim 10, wherein the instructions, when executed by the processor, cause the system to:
redact sensitive information from the video frames prior to inputting the video frames to the generative machine learning model.

12. The system of claim 11, the sensitive information comprising on-screen chat.

13. The system of claim 10, wherein the instructions, when executed by the processor, cause the system to:
output the summary in response to the video game player initiating a subsequent session.

14. The system of claim 13, wherein the instructions, when executed by the processor, cause the system to:
store multiple summaries associated with different save points;
receive user input from the video game player selecting a particular save point; and
select a particular summary to present to the video game player based at least on the particular save point.

15. The system of claim 14, wherein the instructions, when executed by the processor, cause the system to:
store summary timestamps associated with individual summaries;
store save point timestamps associated with the different save points; and
select the particular summary by matching a particular save point timestamp associated with the particular save point to a particular summary timestamp associated with the particular summary.

16. The system of claim 10, wherein the instructions, when executed by the processor, cause the system to:
provide the generative machine learning model with context describing the game when instructing the generative machine learning model to generate the respective frame narratives.

17. The system of claim 10, wherein the instructions, when executed by the processor, cause the system to:
instruct the generative machine learning model to pay attention to certain types of objects in the individual video frames.

18. The system of claim 17, wherein the instructions, when executed by the processor, cause the system to:
instruct the generative machine learning model to ignore other types of objects in the individual video frames.

19. The system of claim 10, wherein the instructions, when executed by the processor, cause the system to:
instruct the generative machine learning model to generate a prompt; and
input the generated prompt to the generative machine learning model to generate the respective frame narratives.

20. A computer-readable storage medium storing instructions which, when executed by a processing device, cause the processing device to perform acts comprising:
collecting a sequence of video frames that are output during a video game session involving a video game player playing a video game;
instructing a generative machine learning model to generate respective frame narratives describing individual video frames from the sequence;
instructing the generative machine learning model to generate an overall narrative describing the video game session based at least on the respective frame narratives; and
outputting a summary of the video game session to the video game player, the summary including the overall narrative and the individual video frames.
